(19) United States
(12) Patent Application Publication
(10) Pub. No.: US 2008/0314181 A1
(43) Pub. Date: Dec. 25, 2008

(54) Robotic Manipulator with Remote Center of Motion and Compact Drive

(76) Inventor: Bruce Schena, Menlo Park, CA (US)

Correspondence Address: INTELLECTUAL PROPERTY DEPT.;INTUTIVE SURGICAL, INC., 1266 KIFER ROAD, BLDG. 101, SUNNYVALE, CA, 94086, US

(21) Appl. No.: 11/765,278

(22) Filed: Jun. 19, 2007

(51) Int. Cl. G05G 3/00; H02K 7/20

(52) U.S. Cl. 74/469; 310/112; 901/15; 901/27; 901/19

(57) ABSTRACT

A robotic manipulator device includes a robotic linkage to rotate an insertion axis about a remote center of motion with two degrees of freedom. A driven link supports the insertion axis. Rigid links in a parallelogram arrangement constrain the driven link to move in parallel to a drive link and the insertion axis to rotate about the remote center of motion. A drive unit has an output shaft coupled to the drive link. Rotation of an input shaft causes the output shaft to rotate. The input and output shafts are at a substantial angle. A housing supports the output shaft. A first motor causes the input shaft to rotate the output shaft. A second motor causes the housing to rotate, rotating the output shaft about an axis that is substantially parallel to the input shaft and passes through the remote center of motion.

### BACKGROUND

In certain applications it is desirable to provide a robotic manipulator device having an end effector that can pass through a small opening in a wall. One way this can be done is to introduce the end effector along an insertion axis with the axis constrained to rotate about a point substantially at the point where the insertion axis intersects the wall, which may be termed the center of motion for the insertion axis.

It will be appreciated that the position of the end effector can be expressed in a spherical coordinate system with an origin at the center of motion. The end effector position may be expressed as two angular displacements and a radius, which is the distance from the center of motion to the end effector. Thus the end effector can be positioned at any point within the range of motion of the robotic manipulator while passing through a small opening in a wall.

One application of such a robotic manipulator is the positioning of an end effector for performing surgical procedures. Minimally invasive surgery (MIS) provides surgical techniques for operating on a patient through small incisions using a camera and elongate surgical instruments introduced to an internal surgical site, often through trocar sleeves or cannulas. The surgical site often comprises a body cavity, such as the patient's abdomen. The body cavity may optionally be distended using a clear fluid such as an insufflation gas. In robotic minimally invasive surgery, the surgeon manipulates the tissues using end effectors of the elongate surgical instruments by remotely manipulating the instruments while viewing the surgical site on a video monitor.

It may be impractical to place the motors for positioning the insertion axis in proximity to the center of motion. For example, in a surgical application it is desirable to minimize the amount of equipment at the incision site to allow the medical personnel direct visibility and access to the site. The robotic manipulator may include linkages to couple the motors for positioning the insertion axis at a distance from the center of motion. In such a robotic manipulator the center of motion may be referred to as a remote center of motion.

U.S. Pat. No. 5,817,084 discloses an exemplary linkage that provides a remote center of motion. The disclosed linkage arrangement allows the motors for positioning the insertion axis to be at a distance from the center of motion. However, the first motor is required to move the entire mass of the second motor in the disclosed linkage arrangement. This requires a larger first motor. The second motor sweeps out a volume as it is moved. Both of these shortcomings increase the mass and bulk of the disclosed linkage arrangement.

A robotic manipulator that supports and positions an insertion axis with a remote center of motion may be a cantilevered structure. The manipulator may be supported from an end of the structure opposite the end that supports the insertion axis. It is desirable that robotic manipulators be stiff so that the position of the end effector can be controlled with great precision. Stiffness may be achieved by providing a structure with a high resonant frequency and a low moment of inertia. Thus it is desirable to minimize the mass or the manipulator and the distance of the mass from the supported end of the cantilevered structure. The motors of the robotic manipulator, typically servo motors, that move the insertion axis are typically massive and bulky. It is desirable to provide a structure for the robotic manipulator that places the motors in a compact configuration that minimizes the contribution of the motors to the moment of inertia of the robotic manipulator.

### SUMMARY

A robotic manipulator device includes a robotic linkage to rotate an insertion axis about a remote center of motion with two degrees of freedom. A driven link supports the insertion axis. Rigid links in a parallelogram arrangement constrain the driven link to move in parallel to a drive link and the insertion axis to rotate about the remote center of motion. A drive unit has an output shaft coupled to the drive link. Rotation of an input shaft causes the output shaft to rotate. The input and output shafts are at a substantial angle. A housing supports the output shaft. A first motor causes the input shaft to rotate the output shaft. A second motor causes the housing to rotate, rotating the output shaft about an axis that passes through the remote center of motion.

Other features and advantages of the present invention will be apparent from the accompanying drawings and from the detailed description that follows below.

### BRIEF DESCRIPTION OF THE DRAWINGS

The present invention is illustrated by way of example and not limitation in the figures of the accompanying drawings, in which like references indicate similar elements and in which:

FIG. 1 is a side view of a schematic representation of a robotic manipulator device that embodies the invention in a first position.

FIG. 2 is a side view of the robotic manipulator device of FIG. 1 in a second position.

FIG. 3 is an end view of the robotic manipulator device of FIG. 1.

FIG. 4 is an end view of the robotic manipulator device of FIG. 1 in a third position.

FIG. 5 is a side view of a schematic representation of a portion of another robotic manipulator device that embodies the invention.

FIG. 6 is a side view of a schematic representation of a portion of another robotic manipulator device that embodies the invention.

FIG. 7 is a side view of a schematic representation of a portion of another robotic manipulator device that embodies the invention.

FIG. 8 is a pictorial view of another robotic manipulator device that embodies the invention.

FIG. 9 is a side view of the robotic manipulator device of FIG. 8.

FIG. 10 is an end view of the driven end of the robotic manipulator device of FIG. 8.

FIG. 11 is an end view of the drive end of the robotic manipulator device of FIG. 8.

FIG. 12 is a side view of a schematic representation of the robotic manipulator device that corresponds to the view of FIG. 9.

FIG. 13 is a side view of a schematic representation of another robotic manipulator device.

FIG. 14 is a side view of a schematic representation of another robotic manipulator device.

### DETAILED DESCRIPTION

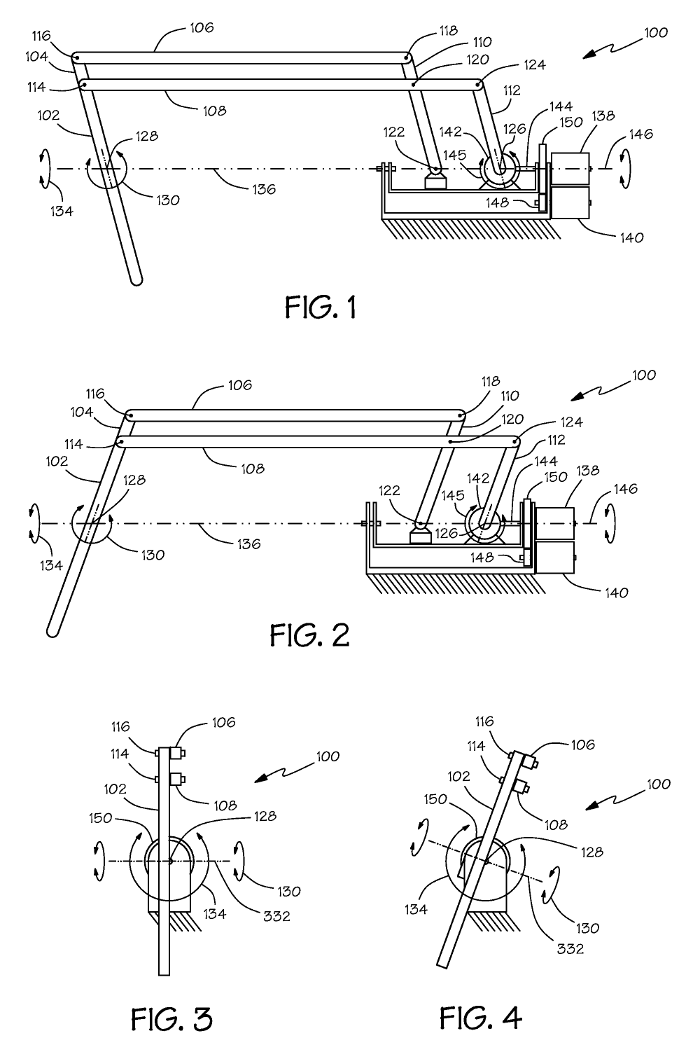

FIGS. 1 through 4 show a robotic manipulator device that embodies the invention. The robotic manipulator device includes a linkage 100 that supports an insertion axis 102 and constrains its movement. More specifically, linkage 100 includes rigid links 104, 106, 108, 110, 112 coupled together by rotational joints 114, 116, 118, 120, 122, 124, 126 in a parallelogram arrangement so that the insertion axis 102 rotates around a point in space 128. The point in space 128 may be referred to as a remote center of motion.

The parallelogram arrangement constrains rotation of the insertion axis 102 to pivoting 130 about an axis 332 (see FIG. 3), sometimes called the pitch axis. The linkage 100 is pivotally mounted so that the linkage and the supported insertion axis 102 further rotate 134 about a second axis 136, sometimes called the yaw axis. The pitch and yaw axes intersect at the remote center 128, which is aligned along the insertion axis 102.

The linkage 100 is driven by a first motor 138 to pivot the insertion axis 102 about the pitch axis 332. The pivotal mounting of the linkage 100 is driven by a second motor 140 so that the linkage and the supported insertion axis 102 further rotate 134 about the yaw axis 136. These motors actively move the linkage 100 and the supported insertion axis 102 in response to commands from a processor.

The robotic linkage 100 has a drive link 112 and a driven link 104 that supports the insertion axis 102. In the embodiment illustrated the insertion axis 102 is collinear with the driven link 104. In other embodiments the insertion axis may be supported at a fixed angle to the driven link. The drive link 112 and the driven link 104 are coupled by a plurality of rigid links 106, 108, 110 in a parallelogram arrangement to constrain the insertion axis 102 to rotate about a remote center of motion along the insertion axis.

The robotic linkage 100 has a drive unit 142 having an output shaft 126 with a first axis of rotation coupled to the drive link 112. A housing of the drive unit 142 supports the output shaft 126. The drive unit 142 has an input shaft 144 with a second axis of rotation 146 at a substantial angle to the first axis of rotation. For example, the drive unit 142 may be a right angle drive with the second axis perpendicular to the first axis. A first motor 138 is coupled to the input shaft 144 of the drive unit 142. Rotation of the input shaft 144 by the first motor 138 causes the output shaft 126 to rotate 145 the drive link 112. Rotation of the drive link 112 is coupled to the insertion axis 102 by the linkage 100, causing the insertion axis to pivot about the pitch axis 332. FIG. 2 shows the robotic manipulator device of FIG. 1 after the insertion axis 102 has pivoted 130 about the pitch axis.

A second motor 140 is coupled to the housing of the drive unit 142 to rotate the housing and the supported output shaft 126 about a third axis of rotation 136 that is substantially parallel to the second axis of rotation 146, the third axis of rotation passing through the remote center of motion 128. In FIGS. 1-4, the third axis of rotation 136 is collinear with the second axis of rotation 146. FIG. 7, discussed below, shows an embodiment where the third axis of rotation is not collinear with the second axis of rotation.

The second motor 140 may be coupled to the housing of the drive unit 142 by gears 148, 150 to allow the second motor to be located adjacent to the first motor 138. In other embodiments, the second motor 140 may be coupled to the housing of the drive unit 142 by other means such as a timing belt and pulleys or a chain drive. It will be appreciated that this allows the motors to be arranged in a compact configuration that is distant from the remote center of motion.

As seen in FIGS. 3 and 4, rotating the housing of the drive unit 142 and the supported output shaft 126, causes the linkage 100 and the supported insertion axis 102 to rotate 134 because they are coupled to the output shaft. The output shaft 126 rotates about the third axis of rotation 136, which passes through the remote center of motion 128. Thus the second motor 140 rotates 134 the insertion axis 102 about the yaw axis 136. FIG. 4 shows the robotic manipulator device of FIG. 3 after the insertion axis 102 has rotated 134 about the yaw axis.

The second motor 140 is mechanically grounded by being rigidly coupled to the common support for the entire robotic manipulator device. In some embodiments, the first motor 138 is also mechanically grounded by being rigidly coupled to the common support. If the first motor 138 is mechanically grounded, it will be appreciated that rotation of the housing of the drive unit 142 by the second motor 140 will cause the input shaft 144 to rotate relative to the housing and cause the output shaft 126 to rotate if the first motor is not rotating. When the first motor 138 is mechanically grounded it may be desirable to provide a decoupling rotation of the first motor 138 responsive to rotation of the second motor 140 so that rotation of the second motor does not produce a rotation 146 of the output shaft 126 to cause the insertion axis 102 to pivot about the pitch axis 332. It will be appreciated that the motor stators will not contribute to the moment of inertia of the linkage 100 when both are mechanically grounded.

In other embodiments, the first motor 138 is supported by being rigidly coupled to the housing of the drive unit 142. This avoids the coupling of rotation of the second motor 140 to cause the insertion axis 102 to pivot about the pitch axis 332. It will be appreciated that the stator of the first motor will then contribute to the moment of inertia of the linkage 100. The contribution to the moment of inertia may be minimized in these embodiments because the first motor is being rotated substantially about its center of gravity. The contribution to the moment of inertia in these embodiments will generally be much less than prior art configurations in which the pitch motor axis is parallel to the pitch axis of the insertion axis.

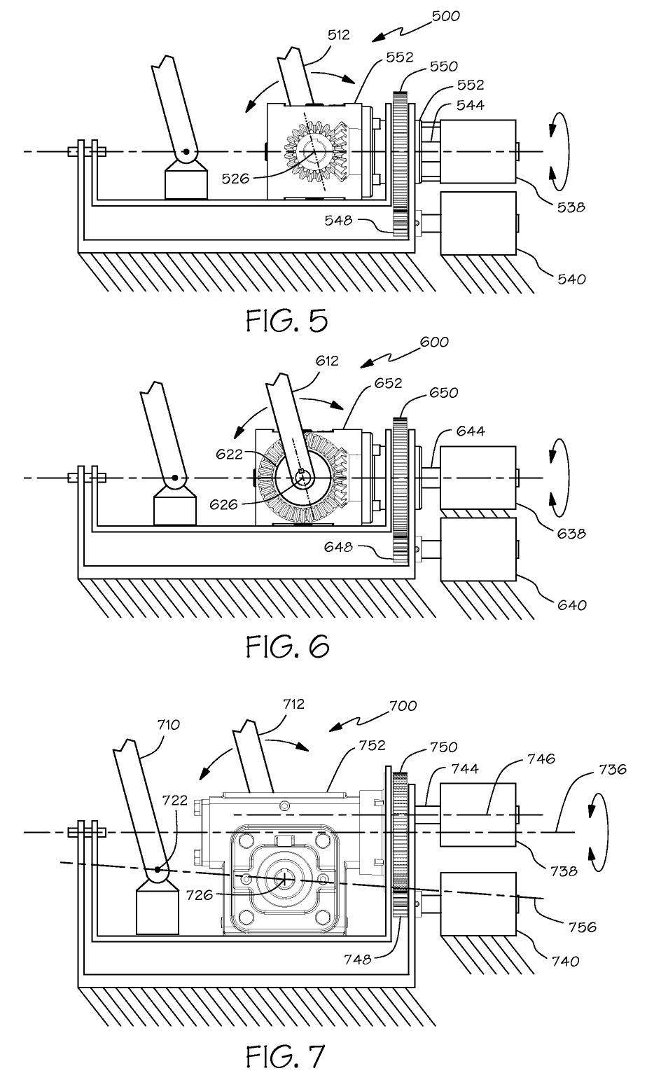

FIG. 5 shows a potion of a robotic manipulator device 500 that embodies the invention showing the motors 538, 540 and drive unit 552 in greater detail. In the embodiment illustrated, the drive unit 552 is a right angle gear drive. The driven link 512 is coupled to one of a pair of bevel gears by the output shaft 526. The first motor 538 is rigidly coupled to and supported by the housing of the drive unit 552. The output shaft of the first motor 538 is coupled to the input shaft 544 of the drive unit 552. The second motor 540 is coupled to the housing of the drive unit 552 by gears 548, 550 as previously described.

FIG. 6 shows a potion of another robotic manipulator device 600 that embodies the invention showing the motors 638, 640 and drive unit 652 in greater detail. In this embodiment, the drive unit 652 is a right angle gear drive. The driven link 612 is coupled to the output shaft 626 of a gear reducer 622, such as a planetary gear train. The input of the gear reducer 622 is coupled to one of a pair of bevel gear. The use of a gear reduction between bevel gears and the driven link may advantageously reduce the effect of backlash in the bevel gears. The output shaft of the first motor 638 is coupled to the input shaft 644 of the drive unit 652. The second motor 640 is coupled to the housing of the drive unit 652 by gears 648, 650 as previously described. In this embodiment, both motors 638, 644 are shown as mechanically ground. A decoupling rotation of the first motor 638 from the second motor 640 may be desirable as previously described.

FIG. 7 shows a potion of another robotic manipulator device 700 that embodies the invention showing the motors 738, 740 and drive unit 752 in greater detail. In this embodiment, the drive unit 752 may be a right angle worm gear drive. The axis 746 of the input shaft 744 for the drive unit 752 in the embodiment shown does not intersect the axis 726 of the output shaft 726. The second motor 740 is coupled to the housing of the drive unit 752 by gears 748, 750 as previously described. In this embodiment, the axis of rotation 736 for the drive unit 752 housing does not intersect the axis of the output shaft 726. If the base 756 of the parallelogram arrangement of the linkage 700 intersects the axis of rotation 736 for the drive unit 752, the intersection will be a remote center of motion for the robotic manipulator device. The base 756 of the parallelogram arrangement is the imaginary line on the plane of the linkage 700 that passes through the axis of the output shaft 726 and the adjacent pivot 722 of the link 710 that is parallel to the drive link 712.

In the embodiment shown FIG. 7, the axis of rotation 746 of the input shaft 744 for the drive unit 752 is displaced from the axis of rotation 736 for the drive unit housing. The first motor 738 may be directly coupled to the input shaft 744 and the first motor mechanically grounded to the drive unit housing. In another embodiment (not shown) the first motor may be coupled to the input shaft by a mechanical arrangement, such as gears or a belt drive, with the axis of rotation for the first motor collinear with the axis of rotation for the drive unit housing.

FIGS. 8-12 show another robotic manipulator device that embodies the invention. The robotic manipulator device includes a linkage 800 that supports an insertion axis 802. Linkage 800 includes rigid links 804, 806, 808, 810, 812 coupled together by rotational joints 814, 816, 818, 820, 822, 824, 826 in a parallelogram arrangement so that the insertion axis 802 rotates around a remote center of motion 828.

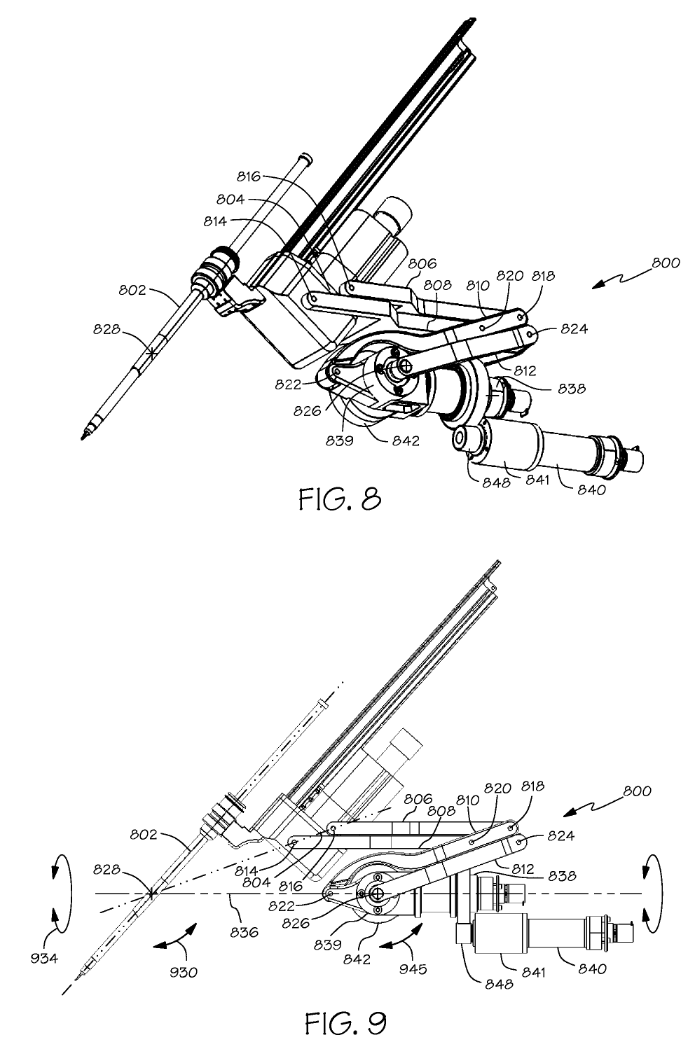

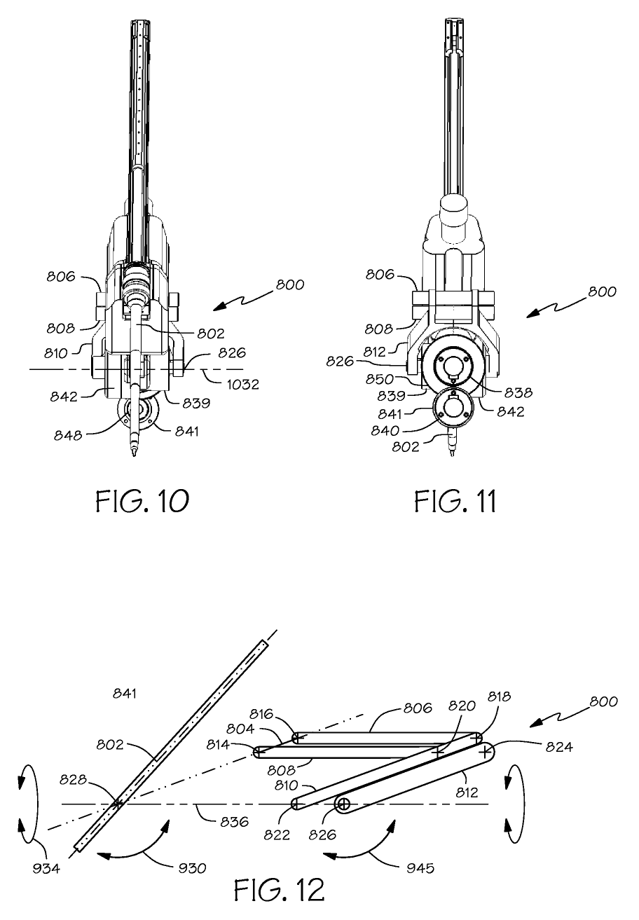

FIG. 9 shows a side view of the device which allows the kinematics to be more clearly seen. It will be seen that the insertion axis 802 of this embodiment is supported at a fixed angle relative to the driven link 804 of the parallelogram arrangement. Since the pivots 814, 816 lie on a line that intersects the remote center of motion 828, the parallelogram arrangement constrains rotation of the insertion axis 802 to pivoting 930 about a pitch axis 1032 (see FIG. 10). The linkage 800 is pivotally mounted so that the linkage and the supported insertion axis 802 further rotate 834 about a yaw axis 836. The pitch and yaw axes intersect at the remote center 828.

The robotic linkage 800 has a drive unit 842 coupled to the drive link 812 by a planetary gear reducer 839. A housing of the drive unit 842 supports the output shaft 826 that in turn supports the linkage 800. The drive unit 842 has an input shaft 844 with a second axis of rotation 846 perpendicular to the first axis of rotation. A first motor 838 is directly coupled to the input shaft of the drive unit 842. Rotation of the input shaft 844 by the first motor 838 causes the output shaft 826 to rotate 945 the drive link 812. Rotation of the drive link 812 is coupled to the insertion axis 802 by the linkage 800, causing the insertion axis to pivot about the pitch axis 1032.

A second motor 840 is coupled by a planetary gear box 841 and a gear train 848 to the housing of the drive unit 842. The second motor 840 rotates the housing and the supported output shaft 826 about the yaw axis 836 that is substantially collinear with the input shaft of the drive unit 842. The case of the second motor 840 is mechanically grounded by being rigidly coupled to the common support for the entire robotic manipulator device. The remaining portions of the robotic manipulator device are coupled to the common support by the case of the second motor 840.

The first motor 838 is supported by being rigidly coupled to the housing of the drive unit 842. It will be appreciated that rotation of the housing of the drive unit 842 by the second motor 840 will rotate the entire first motor 838 in unison with the drive unit so that the input shaft of the drive unit does not rotate relative to the housing.

FIG. 10 is a view of the robotic manipulator device from the driven end in which the relationship of the insertion axis 802 to the pitch axis 1032 and the linkage 800 may be seen. FIG. 11 is a view of the robotic manipulator device from the drive end in which the relationship of the motors 838, 840 to the linkage 800 may be seen.

FIG. 12 is a schematic representation of the parallelogram arrangement of the linkage 800 of the robotic manipulator device that corresponds to the view of FIG. 9. The base of the parallelogram arrangement is formed by the imaginary line that passes through the axis of output shaft 826 and the adjacent link pivot 822 in the plane of the linkage 800. The intersection of the base line and the imaginary line that passes through the axes of the driven link 804 pivots 814, 816 in the plane of the linkage is the remote center of motion 828 for the linkage 800. The plane of the linkage is the plane that is perpendicular to the pivot axes 814, 816, 818, 820, 822, 824 of the linkage and that passes through the remote center of motion 828 for the linkage. It will be appreciated that the linkage has thickness that may extend to either side of the plane of the linkage. The insertion axis 802 may be rigidly connected to the driven link 804 at an arbitrary angle such that the insertion axis passes through the remote center of motion 828. The linkage 800 constrains the motion of the insertion axis 802 to rotation about the remote center of motion around the pitch axis responsive to rotation of the output shaft 826.

In this embodiment, the yaw axis 836 is collinear with the base of the parallelogram arrangement. Since the yaw axis passes through the remote center of motion 828 for the linkage 800, rotation of the linkage and the supported insertion axis 802 about the yaw axis is constrained to rotating the insertion axis 802 to rotation about the remote center of motion around the yaw axis.

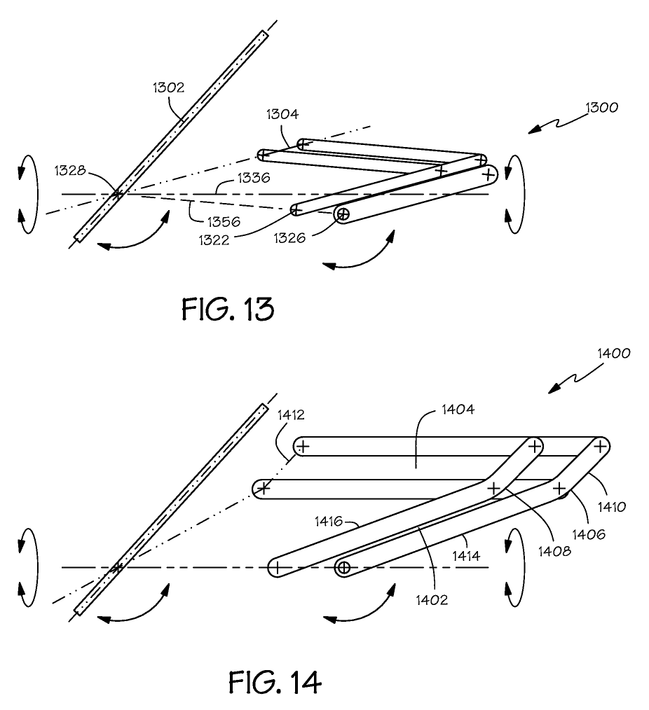

As may be seen in FIG. 13, a schematic representation of another embodiment, the yaw axis 1336 may be at a fixed angle to the base 1356 of the parallelogram arrangement. This embodiment may use a drive unit similar to the one shown in FIG. 7. If the base and the yaw axis intersect at the remote center of motion 1328 for the linkage 1300, the robotic manipulator device will provide the desired constrained motion of rotation of the insertion axis 1302 about the remote center of motion with two degrees of freedom.

As may be seen in FIG. 14, a schematic representation of another embodiment 1400, the sides of the two parallelograms 1402, 1404 that form the parallelogram arrangement need not be collinear. This embodiment may use a drive unit similar to the one shown in FIG. 7. Links 1406, 1408 with a “dogleg” form may be used so that the sides 1410, 1412 of the second parallelogram 1404 are at a fixed angle to the sides 1414, 1416 of the first parallelogram 1402. This may provide a more favorable use of space in some embodiments of the invention.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

What is claimed is:

1. A robotic manipulator device comprising:
a robotic linkage having a drive link and a driven link that supports an insertion axis, the drive link and the driven link coupled by a plurality of rigid links in a parallelogram arrangement to constrain the driven link to constrain the insertion axis to rotate about a remote center of motion along the insertion axis;
a drive unit having an output shaft with a first axis of rotation coupled to the drive link, an input shaft with a second axis of rotation at a substantial angle to the first axis of rotation, rotation of the input shaft causing the output shaft to rotate, and a housing that supports the output shaft;
a first motor coupled to the input shaft of the drive unit to rotate the output shaft about the second axis of rotation; and
a second motor coupled to the housing of the drive unit to rotate the output shaft about a third axis of rotation that passes through the remote center of motion.

2. The robotic manipulator device of claim 1 wherein the driven link supports the insertion axis at a fixed angle to a longitudinal axis joining pivot points of the driven link, the longitudinal axis intersecting the insertion axis at the remote center of motion.

3. The robotic manipulator device of claim 1 wherein the third axis of rotation is collinear with the second axis of rotation.

4. The robotic manipulator device of claim 1 wherein the second axis of rotation intersects the first axis of rotation at a right angle.

5. The robotic manipulator device of claim 1 wherein the first motor is coupled to the housing of the drive unit.

6. The robotic manipulator device of claim 1 wherein the first motor is coupled to the second motor.

7. The robotic manipulator device of claim 1 wherein the output shaft is coupled to the drive link by a gear reducer.

8. A robotic manipulator device comprising:
a robotic linkage having a drive link and a driven link that supports an insertion axis, the drive link and the driven link coupled by a plurality of rigid links in a parallelogram arrangement to constrain the insertion axis to rotate about a remote center of motion along the insertion axis;
a drive unit having an output shaft with a first axis of rotation coupled to the drive link, an input shaft with a second axis of rotation at a substantial angle to the first axis of rotation, rotation of the input shaft causing the output shaft to rotate, and a housing that supports the output shaft;
means for rotating the input shaft of the drive unit to rotate the output shaft about the second axis of rotation; and
means for rotating the housing of the drive unit to rotate the output shaft about a third axis of rotation that passes through the remote center of motion.

9. The robotic manipulator device of claim 8 wherein the driven link supports the insertion axis at a fixed angle to a longitudinal axis joining pivot points of the driven link, the longitudinal axis intersecting the insertion axis at the remote center of motion.

10. The robotic manipulator device of claim 8 wherein the third axis of rotation is collinear with the second axis of rotation.

11. The robotic manipulator device of claim 8 wherein the second axis of rotation intersects the first axis of rotation at a right angle.

12. The robotic manipulator device of claim 8 wherein the means for rotating the input shaft is coupled to the housing of the drive unit.

13. The robotic manipulator device of claim 8 wherein the means for rotating the input shaft is coupled to the means for rotating the housing of the drive unit.

14. The robotic manipulator device of claim 8 wherein the output shaft is coupled to the drive link by a gear reducer.

15. A two-axis motor drive device comprising:
a drive unit having an output shaft with a first axis of rotation, an input shaft with a second axis of rotation at a substantial angle to the first axis of rotation, rotation of the input shaft causing the output shaft to rotate, and a housing that supports the output shaft;
a first motor coupled to the input shaft of the drive unit to rotate the output shaft about the second axis of rotation; and
a second motor coupled to the housing of the drive unit to rotate the output shaft about a third axis of rotation that passes through the remote center of motion.

16. The two-axis motor drive device of claim 15 wherein the third axis of rotation is collinear with the second axis of rotation.

17. The two-axis motor drive device of claim 15 wherein the second axis of rotation intersects the first axis of rotation at a right angle.

18. The two-axis motor drive device of claim 15 wherein the first motor is coupled to the housing of the drive unit.

19. The two-axis motor drive device of claim 15 wherein the first motor is coupled to the second motor.

20. The two-axis motor drive device of claim 15 further comprising a gear reducer coupled to the output shaft.
